(19) United States
(12) Patent Application Publication
(10) Pub. No.: US 2004/0001131 A1
(43) Pub. Date: Jan. 1, 2004

(54) Method for detecting validity of paper with a printer

(76) Inventors: Kuan-Chih Huang, Taipei Hsien (TW); Hsu-Chu Chien, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 10/064,878

(22) Filed: Aug. 26, 2002

(30) Foreign Application Priority Data
Jun. 27, 2002 (TW) 091114225

(51) Int. Cl. B41J 2/01

(52) U.S. Cl. 347/101

(57) ABSTRACT

A method for detecting validity of paper with a printer is disclosed. The printer includes a scanning device. The method includes using the scanning device to scan marks on the paper before printing to the paper, and comparing output signals generated by the scanning device with predetermined signals so as to determine whether the paper is capable of being used in the printer.

### BACKGROUND OF INVENTION

1. Field of the Invention

The present invention relates to a method for printing, and more particularly, to a method for detecting validity of paper with a printer.

2. Description of the Prior Art

Please refer to FIG. 1. FIG. 1 is a cross-sectional view of a prior art thermal transfer printer 10. The thermal transfer printer 10 comprises a first capstan roller 12 and a first pinch roller 14 that is located above the first capstan roller 12 to press a piece of paper 16 onto the first capstan roller 12. The first capstan roller 12 is driven by a motor (not shown) that is inside the thermal transfer printer 10. The first capstan roller 12 can rotate clockwise and counterclockwise to drive the paper 16 forward and backward with the first pinch roller 14. The thermal transfer printer 10 further comprises a thermal print head 18 and a platen roller 20 that is under the thermal print head 18 and presses the paper 16 against the thermal print head 18 during printing. The thermal print head 18 comprises an ink ribbon (not shown) and heats ink in the ink ribbon to print onto the paper 16. Operation of the thermal transfer print 10 is as follows.

Please refer to FIG. 2. FIG. 2 is a cross-sectional view of the thermal transfer printer 10 showing a front section 16a of the paper 16 being driven under the thermal print head 18. When the printer 10 receives a command to print, the motor inside the printer 10 starts to drive the first capstan roller 12. The first capstan roller 12 and the first pinch roller 14 operating in coordination, drive the paper 16 into the printer 10, as is also shown in FIG. 1 (in FIG. 1, a dashed line indicates the forward path of the paper 16). In addition, the printer 10 further comprises a second capstan roller 22 and a second pinch roller 24 that operate in the same way as the first capstan roller 12 and the first pinch roller 14. When the paper 16 enters the printer 10, it is driven by the second pinch roller 22 until the front section 16a of the paper 16 arrives at the thermal print head 18, as shown in FIG. 2.

The thermal print head 18 starts to print data onto the paper 16 from the front section 16a of the paper 16 to a back section 16b of the paper 16. While printing, the paper 16 moves in direction indicate by a dashed line shown in FIG. 2. The paper 16 is driven by the second capstan roller 22 until the paper 16 reaches between the first capstan roller 12 and first pinch roller 14. The paper 16 is then driven by the first capstan roller 12 until printing is finished and the back section 16b of the paper 16 is again between the first capstan roller 12 and the first pinch roller 14, as shown in FIG. 1. The ink ribbon of the thermal transfer printer 10 has several colors and the thermal print head 18 prints one color onto the paper 16 at a time. In other words, in the preceding printing process, the thermal print head 18 only prints one color. If the thermal print head 18 needs to print two colors onto the paper 16, the printer 10 has to repeat the preceding process to print a second color. After finishing printing all colors, the printer 10 ejects the paper 16.

In the thermal transfer printer 10, the ink ribbon and the paper 16 are important elements. For different types and brands of thermal transfer printers a specific paper is used having specific thickness and material. Users have to use special or specifically produced paper to ensure that a document is successfully printed. Using unsuitable paper causes unsuccessful printing or damage to the printer 10. For example, too thick paper will wear rollers and reduce the lifetime of the printer 10. If the material of the paper used does not properly match the ink ribbon, the paper can become adhered to the ink ribbon. These conditions can seriously damage the printer 10. Because some users are not aware of the suitability of particular paper, they often use other types or brands of paper to print data inadvertently destroying the ink ribbon and damaging the printer 10. Thus, a user needs to choose paper carefully and prevent from using low quality paper.

### SUMMARY OF THE INVENTION

It is therefore a primary objective of the claimed invention to provide a method for detecting validity of paper with a printer to solve the above-mentioned problem.

According to the claimed invention, a method for detecting validity of paper with a printer is provided. The printer includes a scanning device. The method includes using the scanning device to scan marks on the paper before printing to the paper, and comparing output signals generated by the scanning device with predetermined signals so as to determine whether the paper can be used in the printer.

It is an advantage of the claimed invention that the method compares output signals generated by the scanning device with predetermined output signals to prevent unsuitable paper from being used by the printer.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a cross-sectional view of a thermal transfer printer according to the prior art.

FIG. 2 is a cross-sectional view showing operation of the thermal transfer printer of FIG. 1.

FIG. 3 is a cross-sectional view of a thermal transfer printer according to the present invention.

FIG. 4 is a view of a reverse side of a piece of paper according to the present invention.

FIG. 5 is a view of a reverse side of another piece of paper according to the present invention.

FIG. 6 is a view of output signals of the scanning device of FIG. 3.

FIG. 7 is a flowchart of a method for detecting validity of paper with a printer according to the present invention.

### DETAILED DESCRIPTION

Printing paper according to the present invention comprises specific marks. Before printing data onto the paper, a printer scans the mark using a scanning device disposed inside the printer, and compares a signal produced by the scanning device to a predetermined signal so as to determine whether the paper can be used in the printer. Operation of the present invention is as follows.

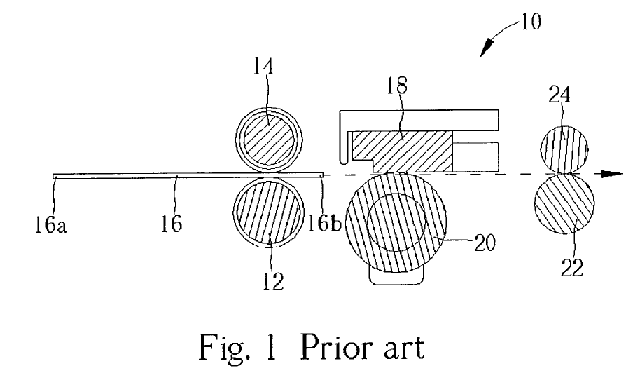

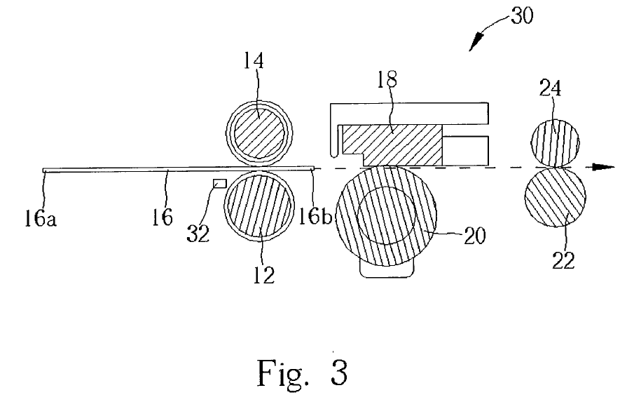

Please refer to FIG. 3. FIG. 3 is a cross-sectional view of a thermal transfer printer 30 according to the present invention. Elements and their functions in the thermal transfer printer 30 according to the present invention are the same as like elements of the thermal transfer printer 10 of FIG. 1. The difference between both is that the printer 30 according to the present invention comprises a scanning device 32 to detect a mark on the sheet of paper 16 to determine the suitability of the paper 16.

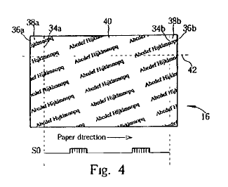

Please refer to FIG. 4. FIG. 4 is a view of a reverse side of the piece of paper 16 according to the present invention. The piece of paper 16 has an obverse side and a reverse side (the reverse side is as shown in FIG. 4). The obverse side is to store an image printed by the printer 30, and the reverse side is to store the mark (schematically shown as “Abcdef Hijklmnopq”). The mark on the reverse side of the sheet, of paper 16 in an example according to the present invention is a watermark containing several words according to a specific format. In addition, the piece of paper 16 comprises a print area 40 that is between a front dashed line 34a and a back dashed line 34b, which is namely the printing area 40 of the thermal print head 18. An area between the front dashed line 34a and a front edge 36a of the piece of paper 16 is a front area 38a. An area between the back dashed line 34b and a back edge 36b of the piece of paper 16 is a back area 38b. The front area 38a and the back area 38b enable the rollers inside the printer 30 to grip the piece of paper 16. The reverse side of the piece of paper 16 according to the present invention has the watermark on the front area 38a, the print area 40, and the back area 38b.

When the piece of paper 16 is fed into the printer 30 in preparation for printing, the printer 30 according to the present invention detects the watermark on the reverse side of the piece of paper 16 using the scanning device 32. A dashed line 42 in FIG. 4 shows the path of the scanning device 32 scanning the paper 16. Because the watermark has contrasting areas, the scanning device 32 outputs a high voltage when it scans dark areas of the watermark. Similarly, the scanning device 32 outputs a low voltage when it scans light areas. After the scanning device 32 scans the piece of paper 16, the scanning device 32 outputs a signal S0 as shown in FIG. 4b. The signal S0 is the output obtained by the scanning device 32 after scanning the print area 40. Because the word in the watermark of the reverse side of the piece of paper 16 is printed in a specific repeated pattern, the scanned signal S0 has high voltage pulses that have specific amplitude and period (or frequency). The printer 30 compares the scanned signal S0 to a predetermined signal. If the output signal S0 is substantially the same as the predetermined signal, meaning the piece of paper 16 is suitable and can be used in the printer 30, the print head 18 starts to print data onto the paper 16. If the output signal S0 does not match the predetermined signal, meaning the piece of paper 16 is not suitable for the printer 30, the printer 30 does not print data onto the piece of paper 16 and ejects the paper 16 immediately. In this way, the printer 30 can determine whether the paper 16 is acceptable for use in the printer 30 by detecting the mark on the paper 16 to prevent unsuitable paper from damaging the printer 30.

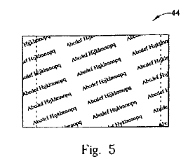

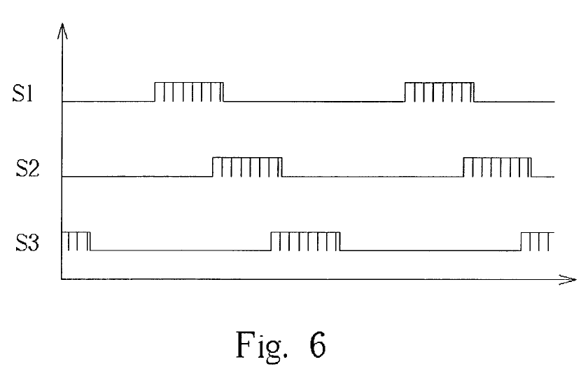

Please refer to FIG. 5 and FIG. 6. FIG. 5 is a view of a reverse side of another sheet of paper 44 according to the present invention. FIG. 6 is a view of output signals S1, S2, and S3 of the scanning device 32 produced by scanning different pieces of paper of the same type. The sheets of paper 16 and 44 are produced from cutting a roll of paper of larger size. For convenience of manufacture, the watermark is printed to the larger roll of paper before cutting. Then, the larger roll is cut resulting in the watermark on the reverse side of different pieces of paper not having completely the same arrangement. As shown in FIG. 4 and FIG. 5, the watermarks on the pieces of paper 16 and 44 are vertically and horizontally shifted relative to each other. Because the watermark is specifically designed and arranged to accommodate this, arrangement of the words in the watermark of the pieces of paper 16 and 44 in FIG. 4 and FIG. 5 are nonetheless coherent. Although the scanning device 32 scanning the pieces of paper 16 and 44 outputs different signals, the signal maintains characteristics such as pulse amplitude and period (or frequency). This is shown in FIG. 6 displaying the output signals S1, S2, and S3 of the scanning device 32 scanning different sheets of paper. Though the output signal is not completely the same, the signals share the aforementioned characteristics. The printer 30 can then make a comparison based on these characteristics to determine whether the sheets of paper 16 and 44 are suitable for the printer 30. The steps of the present invention method are detailed as follows.

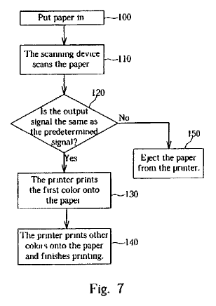

Please refer to FIG. 7. FIG. 7 is a flowchart of a method for detecting validity of paper with a printer. The steps are as follows:

Step 100:

Put the sheet of paper 16 in a paper entrance of the printer 30 and feed it between the first capstan roller 12 and the first pinch roller 14;

Step 110:

The first capstan roller 12 drives the paper 16 forward. At the same time, the scanning device 32 inside the printer 30 starts to scan the paper 16;

Step 120:

The printer 30 compares the output signal of the scanning device to the predetermined signal. If the output signal is the same as the predetermined signal, execute step 130. Otherwise, execute step 150;

Step 130:

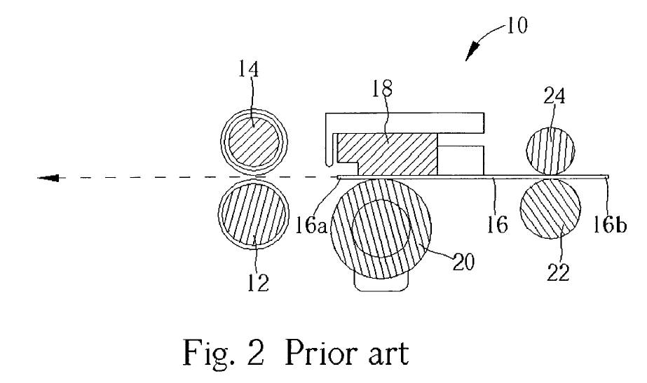

The paper 16 is determined to be suitable for the printer 30. The second capstan roller 22 drives the sheet of paper 16 forward until the front edge 16a of the sheet of paper 16 arrives at below the print head 18 (as shown in FIG. 2), and then the print head 18 starts printing. The second capstan roller 22 rotates in reverse to drive the sheet of paper 16 in an opposite direction. The print head 18 prints data from the front dashed line 34a of the sheet of paper 16 to the back dashed line 34b. After finishing printing one color, execute step 140;

Step 140:

Generally speaking, the print head 18 has to print two or more colors onto the paper 16. Accordingly, the printer 30 has to repeat step 130, that is, use the first capstan roller 12 and the second capstan roller 22 to drive the sheet of paper 16 into the printer 30. Then the print head 18 can print additional colors onto the paper 16. (The print head 18 always prints data from the front dashed line 34a to the back dashed line 34b). Repeat this step until the print head 18 finishes printing all colors. Finally, the sheet of paper 16 is ejected from the printer 30;

Step 150:

The paper 16 is determined to be unsuitable for the printer 30. The first capstan roller 12 rotates in reverse to drive the piece of paper 16 in an opposite direction ejecting the piece of paper 16 from the printer 30 to prevent damage to the printer 30 and the ink ribbon.

According to the above-mentioned procedure, the method according to the present invention can detect the signal produced by the scanning device 32 scanning the mark on the sheet of paper 16 to determine if the paper 16 is suitable for the printer 30 to prevent the paper 16 from damaging the printer 30 and the ink ribbon. In the above-mentioned procedure, the mark on the sheet of paper 16 is a watermark, however, the mark on the paper 16 can be other types of markings or symbols capable of relating information about the sheet of paper 16. For example, drilling a hole through the sheet of paper 16 or printing a specific sign on the front area 38a and the back area 38b are both acceptable alternatives. The printer 30 can determine if the paper 16 is suitable for the printer 30 by referencing the mark. In addition to the thermal transfer printer 30 that is mentioned above, the method of the present invention also applies to a thermal inkjet printer, a dot matrix printer, an inkjet printer, and an electrostatic printer. Furthermore, the scanning device 32 can be an optical, electronic, or similar scanning device that is well understood in the art.

In contrast to the prior art, the present invention printer detects a mark on a sheet of paper using the scanning device before printing to the paper. The printer then compares the signal produced by the scanning device to a predetermined signal to determine if the paper is useable in the printer. Therefore, the present invention is an effective method of preventing the printer from printing onto unsuitable paper and protects the printer and ink ribbon from damage.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method for detecting validity of paper with a printer, the printer comprising a scanning device, the method comprising:
using the scanning device to scan marks on the paper before printing to the paper; and
comparing output signals generated by the scanning device with predetermined signals so as to determine whether the paper is capable of being used in the printer.

2. The method of claim 1 wherein the paper comprises a front area, a back area, and a print area that is between the front area and the back area; and the mark on the paper is only on the front area, the back area, or between the front area and the back area.

3. The method of claim 2 wherein the mark on the paper is a hole.

4. The method of claim 1 wherein the paper comprises an obverse side that is to store an image printed by the printer, and a reverse side that is to store the mark.

5. The method of claim 1 wherein the mark on the paper is a watermark.

6. The method of claim 1 wherein the printer further comprises a print head and an ink ribbon, the print head is used to heat ink in the ink ribbon to print onto the paper.

7. The method of claim 6 wherein the printer further comprises a platen roller to press the paper against the print head.

8. The method of claim 6 wherein the print head is a thermal print head.

9. The method of claim 1 wherein the printer further comprises a capstan roller and a pinch roller to drive the paper forward and backward.

10. The method of claim 9 wherein the printer further comprises a motor to drive the capstan roller to rotate.

11. The method of claim 1 wherein the printer prints one color at a time.

12. The method of claim 1 wherein the printer is a thermal transfer printer.

13. The method of claim 1 wherein the printer is a thermal inkjet printer.

14. The method of claim 1 wherein the printer is a dot matrix printer.

15. The method of claim 1 wherein the printer is an inkjet printer.

16. The method of claim 1 wherein the printer is an electrostatic printer.

17. The method of claim 1 wherein the paper is photo paper.
